(19) United States
(12) Patent Application Publication
(10) Pub. No.: US 2010/0287519 A1
(43) Pub. Date: Nov. 11, 2010

(54) METHOD AND SYSTEM FOR CONSTRUCTING A CUSTOMIZED LAYOUT FIGURE GROUP

(75) Inventor: YI JEN SU, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: ANAGLOBE TECHNOLOGY, INC., HSINCHU (TW)

(21) Appl. No.: 12/463,689

(22) Filed: May 11, 2009

(51) Int. Cl. G06F 17/50

(52) U.S. Cl. 716/10

(57) ABSTRACT

A method and a system for constructing a customized layout figure group are disclosed. The method provides improved options for users to flexibly create a customized figure group design. During the layout process, the layout shape, the leaf device and the nest device with design parameters can be created with built-in figure groups, user's scripts and/or by capturing the user's existing layout.

### BACKGROUND OF THE INVENTION

1. Field of the Invention

The present invention relates to electronic design automation tools for integrated circuit layouts, and more particularly, to a method and system for constructing a customized layout figure group.

2. Description of the Related Art

Integrated circuits or chips are used in most machines and products that have electronic components. Computers, televisions, cameras, cellular phones, audio/video players, etc., all use integrated circuits to build their system. A typical integrated circuit design is initially conceived and tested schematically by a circuit design engineer, with a number of components and devices connected to generate a circuit with desired performance and characteristics. Once the circuit has been designed, it must be reconfigured from the schematic format into a geometric layout format. This is typically a job for a layout engineer, working with a circuit design engineer to create a graphic layout specifying a suitable semiconductor implementation of the circuit.

The geometric layout of the device specifies all of the semiconductor device layout parameters. However, configuring an electronic circuit to a geometric layout is a very complicated task, and is governed by a large number of geometric rules. A geometric layout of a semiconductor device contains geometric features such as polygons to indicate the proper size, shape, location and separation of a certain physical feature of the circuit, distinguishing it from other physical features, or to indicate proper isolation and separation among the circuit elements. The geometric layout of a typical semiconductor device contains multiple layers, each layer having one or more polygons.

Because the process of drawing the layers separately and manually is tedious and prone to error, focus has been applied in recent decades to the development of a layout automation methodology. Software tools, such as electronic design automation (EDA) tools to generate parameterized cells (pcells), have been developed. In a pcell, the designer selects parameters to describe features of electronic components for the design of an integrated circuit, and the tool then generates multiple representations of the electronic components of the pcell based on the parameters. For example, a single pcell may use a transistor's dimensions and number of gate segments as parameters, which is more efficient than requiring many different cell definitions to represent the various transistors within a given design. According to the parameter values, each instance varies in size and composition.

Conventional layout tool systems evaluate the pcell according to its pcell parameters by executing a software program. The result is the defined pcell according to the pcell code. If a parameter changes after this cell is created, the design system automatically triggers a recalculation of the shapes within the cell. The pcell is then viewed from a higher order of the design hierarchy as a cell instance of the chip design. However, the software program used to evaluate the pcell may have long or complicated algorithms, and frequently becomes inefficient and difficult to maintain. Moreover, errors in the complicated software code are difficult to locate. With the layout tools currently on the market, the coverage of the layout method provided is limited, and few specific layout patterns are supported. Therefore, a more flexible design tool is needed to satisfy the user's requirements and speed up the layout design procedure.

### SUMMARY OF THE INVENTION

The objective of the present invention is to provide a method and system for constructing an integrated circuit layout. This invention provides greater flexibility for the user to create a customized cell. Use of the “figure group” concept of creating a cell utilizing built-in figure groups, user scripts and/or existing layout can improve efficiency and convenience for the user constructing a higher-level and complex device.

In order to achieve the objective, the present invention discloses a method for constructing an integrated circuit layout, the method comprising the steps of: (a) arranging a customized layout figure group that is not present in a standard figure group database by reorganizing existing figure groups in the database, capturing a user's existing layout, executing codes of a user's scripts or the combination thereof; (b) setting compaction constraints for the customized layout figure group; (c) generating the customized layout figure group in accordance with the compaction constraints, wherein the customized layout supporting functions as supplement of the standard figure group database.

This invention also discloses a system for constructing an integrated circuit layout, comprising: (a) a standard figure group database comprising a plurality of built-in figure groups; (b) an arrangement engine configured to reorganize built-in figure groups designated by a user; (c) an evaluator connected to the arrangement engine for generating a customized layout figure group that is not present in the standard figure group database in accordance with compaction constraints requested by the user, wherein the customized layout supporting functions as supplement of the standard figure group database.

### BRIEF DESCRIPTION OF THE DRAWINGS

The invention will be described according to the appended drawings in which:

FIG. 1 shows the flowchart for forming a layout in accordance with the present invention;

FIG. 2 illustrates the diagram of the representative hierarchy of an integrated circuit layout structure;

FIGS. 3A through 3C show the polygons with some design parameters provided by the function of the parameterized objects;

FIG. 4A shows the OFFSET MODE;

FIG. 4B shows the ABOUT MODE of the “align” function;

FIG. 5 shows the OR operation function of the derived objects;

FIG. 6 shows a flowchart for generating a MOS device using built-in figure groups;

FIG. 7 shows a final layout device;

FIG. 8 illustrates a primitive existing layout;

FIG. 9 shows a block diagram in accordance with one embodiment of the present invention;

FIG. 10 shows an exemplary stand figure group database;

FIG. 11 shows an exemplary plot of a repetition of derived objects;

FIG. 12 shows an exemplary plot of a fill of derived objects;

FIG. 13 shows an exemplary plot of a bounding box of derived objects;

FIG. 14 shows an exemplary plot of a selection of derived objects;

FIG. 15 shows an exemplary graphical user interface of a query of derived objects;

FIG. 16 shows a processed shapes; and

FIG. 17 shows a flow chart in accordance with one embodiment of the present invention.

### PREFERRED EMBODIMENT OF THE PRESENT INVENTION

In the following detailed description of the invention, reference is made to the accompanying drawings that show by way of illustration exemplary embodiments in which the invention may be applied. These embodiments are described to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the present invention is defined only by the appended claims.

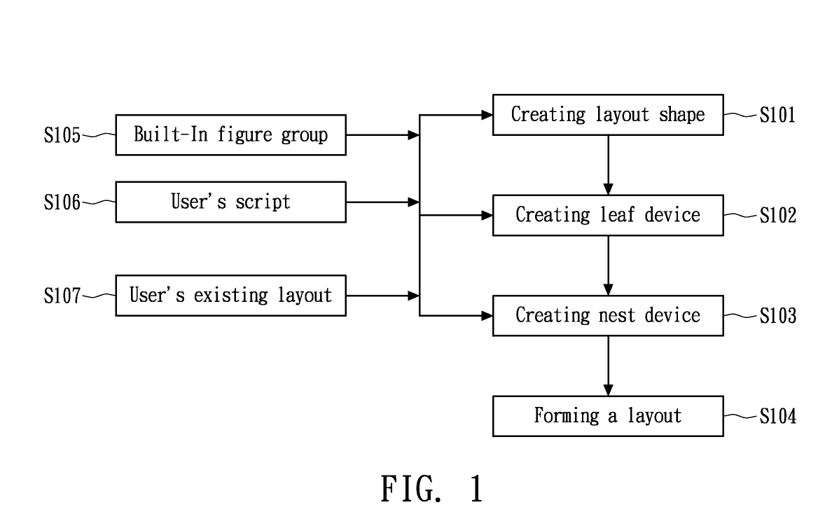

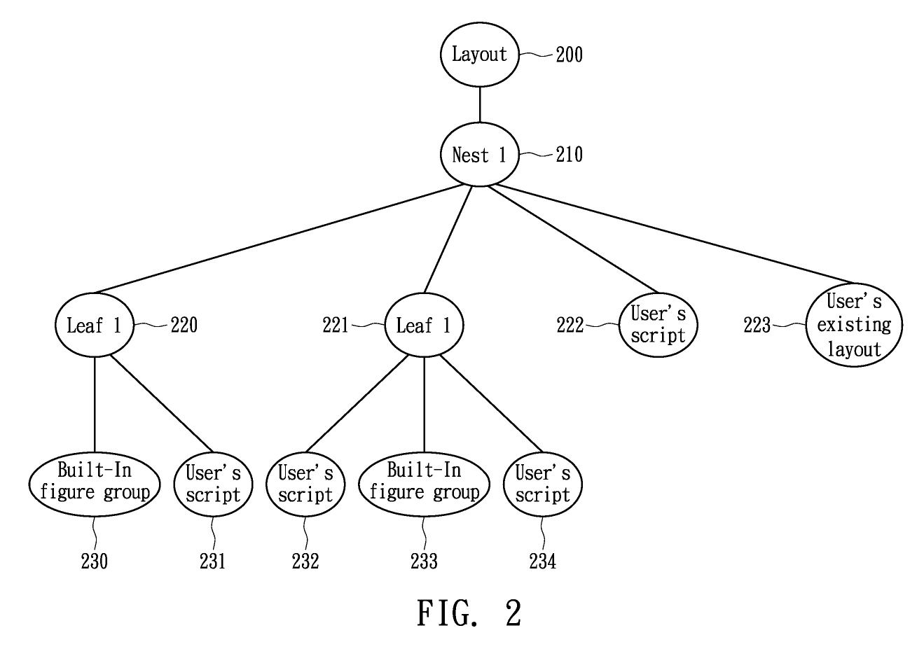

A description of one embodiment of the invention is provided in this section. FIG. 1 shows the flowchart for forming a layout in accordance with one embodiment of the present invention. In FIG. 1, steps S101-S107 are performed to create layout shapes, a leaf device and/or a nest device and then to form a layout. FIG. 2 illustrates the diagram of the representative hierarchy of an integrated circuit layout structure. Leaf-level devices 220 and 221 are defined by relating five first-order figure groups, named figure groups 230-234. An additional level device, nest device 210, is defined by relating four leaf-level devices, named devices 220-223.

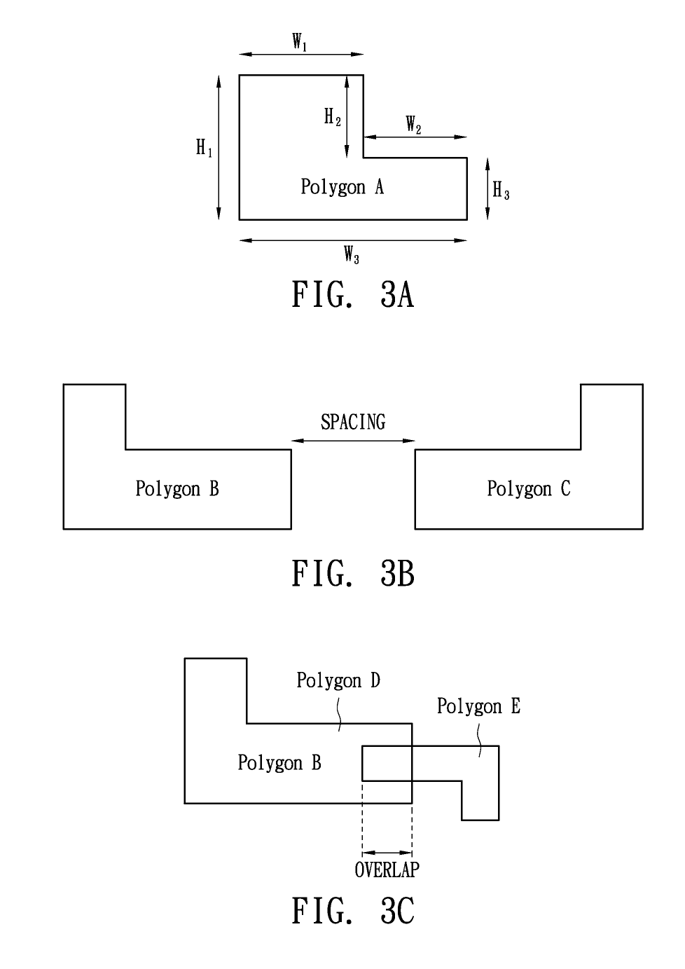

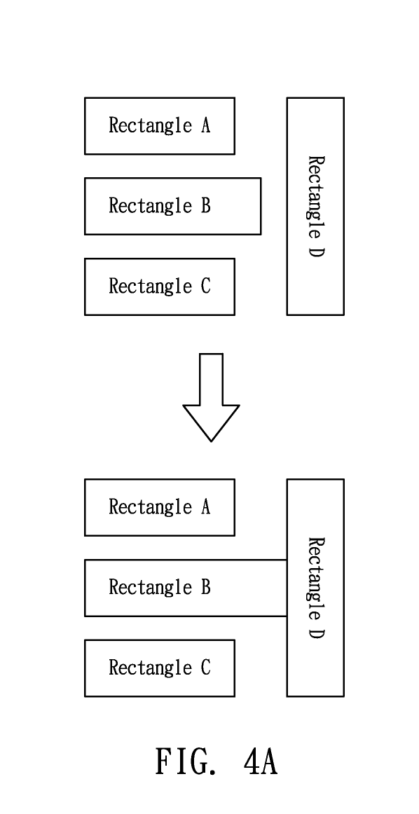

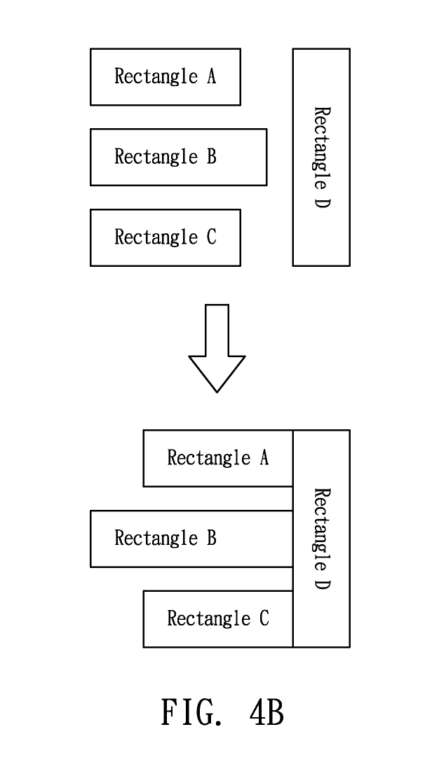

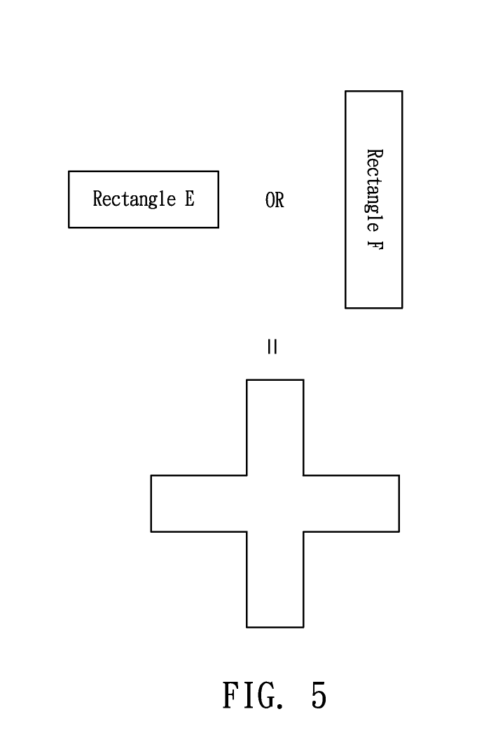

Some figure groups such as figure group 230 and figure group 233 are created with a set of design parameters from built-in figure groups. The built-in figure groups can be provided by a layout software. The built-in figure groups include parameterized objects and layout groups. The parameterized objects include a rectangle, a polygon, a path, a path segment, a text, a polygon text, a scalar instance, an array instance, a path segment, an ellipse, and a donut. The layout groups include an editor such as a move, a stretch and a align; derived objects such as an operation, a repetition (absolute/relative), a fill, a bounding box, a selection, a query and cut corners; devices such as guard-ring and transistor; user program groups which are written in C language, C++, Tool Command Language (TCL), Python, Perl or the combination thereof; a compactor which executes rule constraints; and a placer and a router. For example, as shown in FIG. 3A through FIG. 3C, polygons with some design parameters are provided by the functions of the parameterized objects. The set of design parameters contains a set of design rules such as width (W1, W2, W3), height (H1, H2, H3), SPACING between two adjacent intra-layer polygons, OVERLAP between two interlayer polygons, a set of design constraints such as the width and length of a gate of a MOS device, and a set of user constraints such as die aspect ratio. Additional examples of the functions are provided from the editors and derived objects, respectively. FIG. 4A and FIG. 4B show the OFFSET MODE and the ABOUT MODE of the “align” function, respectively. FIG. 5 shows the OR operation function of the derived objects.

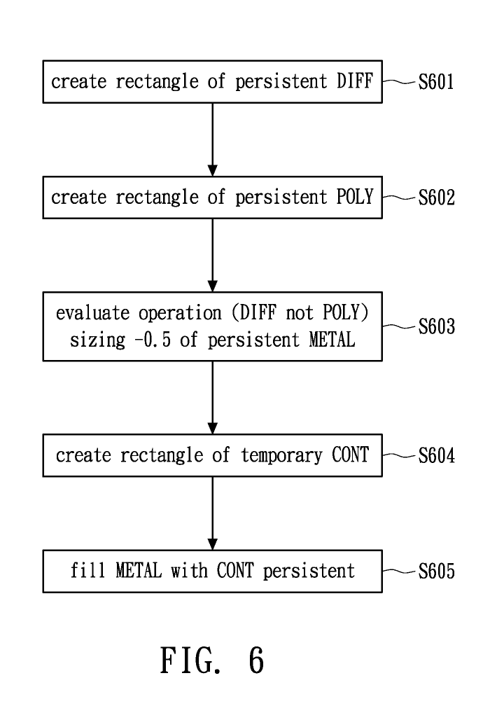

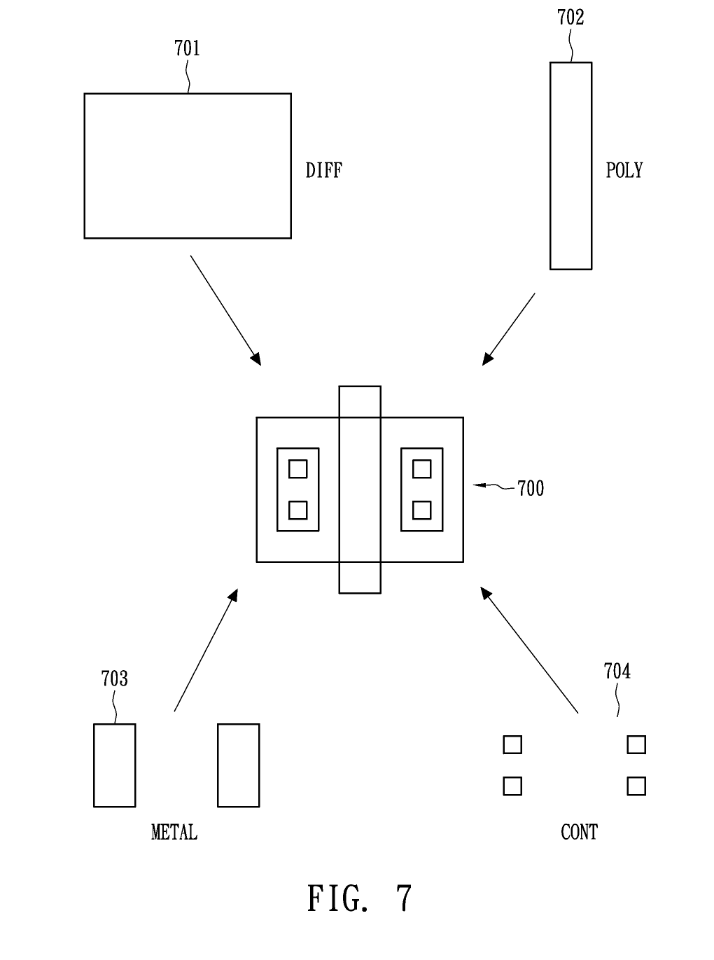

FIG. 6 shows a flowchart for generating a MOS device using built-in figure groups. In step S601, utilizing the “rectangle” object of the parameterized objects of the built-in groups creates a persistent DIFF. In step S602, the “rectangle” object is utilized again to create a persistent POLY. In step S603, the “operation” of the derived objects is utilized to evaluate the operation. In step S604, the “rectangle” object is utilized once more to create a temporary CONT. In step S605, using “fill” fills the METAL with the CONT, and then creates the final layout device, i.e., MOS, as shown is FIG. 7. The above steps can be accomplished by a generic code as follows:

```
    A: parameters {storage=persistent, layer=DIFF, x=0, y=0, width=10,
height=5}
    B: parameters {storage=persistent, layer=POLY, x=4, y=−1, width=2,
height=7}
    C: parameters {storage=persistent, layer=METAL,
operation=“(A not B) sizing −0.5”}
    D: parameters {storage=temporary, layer=CONT, x=0, y=0, width=1,
height=1}
    E: parameters={storage=persistent, area=C, object=D}
```

Therefore, by applying these functions provided from built-in figure groups, a figure group with one or more layers can be constructed.

On the other hand, some figure groups such as figure group 231, figure group 232 and figure group 234 are created with a set of design parameters by executing code of the user's script. These design parameters comprise a set of design rules and a set of design constraints that are specified by the user. The user's scripts could be in C language, C++, Java, Tool Command Language (TCL), Python or Perl. An example TCL for generating a MOS is as follows:

proc createMOS {arguments} {

set mos [golf::createHandle $arguments]
set argA [golf::createArguments $mos $arguments]
golf::setStringParam $argA “ name” “ A”
golf::setStringParam $argA “ layer” “ DIFF”
golf::setUUParam $argA “ width” 10
...

golf::createRect $mos $argA
set argB [golf::createArguments $mos $arguments]
...
golf::createRect $mos $argB
...
golf::createOperation $mos $argC
...
golf::createRect $mos $argD
...
golf::createFill $mos $argE
golf::closeHandle $mos

}

Another example using C++ code for generating a MOS is as follows:

void user::createMOS(golf::FigGroup* mos)

{

golf::Handle A(mos);
A.setStringParam(“ name” , “ A” );
A.setStringParam(“ layer” , “ DIFF” );
A.setIntParam(“ width” , 10);
...
mos->createRect(&A);
golf::Handle B(mos);
...
mos->createRect(&B);
...
mos->createOperation(&C);
...
mos->createRect(&D);
...
mos->createFill(&E);

}

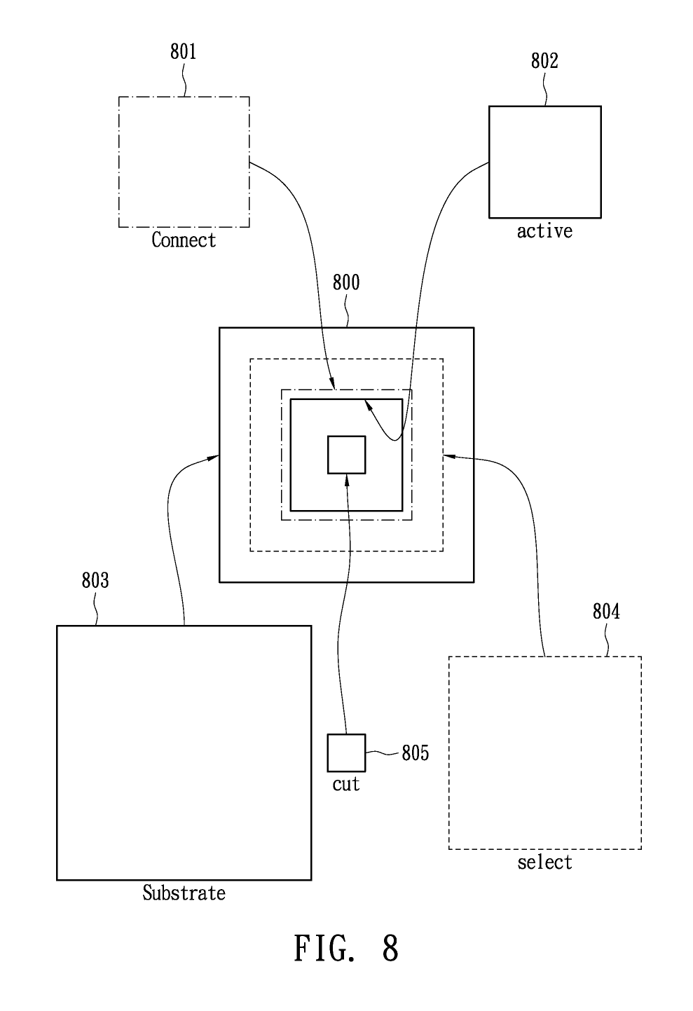

An additional level device of the hierarchical structure is a nest-level device 210 constructed by four leaf-level devices, named devices 220-223. That is, the user can connect some leaf devices and polygons to form a nested device. As mentioned above, leaf devices 220 and 221 are defined by relating five first-order figure groups, e.g., figure groups 230-234. On the other hand, a leaf-level device can also be defined by a user's script (leaf device 222) or a user's existing layout (leaf device 223). FIG. 8 illustrates a primitive existing layout. For capturing a user's existing layout, the user first captures a set of design parameters from the user's existing layout. The set of design parameters comprises a set of design rules and a set of design constraints, which are modifiable by the user for reuse. The set of design rules and design constraints can be modified by the user at this step or later. The user also can capture a plurality of primitive objects from the user's existing layout. The step of capturing the primitive objects from the user's existing layout comprises the steps of: (1) defining a layer usage of each layer captured from the user's existing layout, wherein the layer usage such as Active, Poly or Metal is commonly used in the field of circuit layout; (2) identifying the primitive objects according to the layer usages, where the identified primitive objects comprise the CUT object, the GATE object and the PATH object; and (3) saving the primitive objects into a persistent or temporary space for reuse.

Once the nest device 210 is formed, a step of compaction constraints for the nested devices is defined to form a final layout. The compaction constraints comprise: (1) a set of design constraints such as match pattern (asymmetry or symmetry) and inter-digitations patterns for array (common axis or centroid); (2) a set of design rules; and (3) a set of user constraints such as die aspect ratio and fixed distance between devices. When the user adjusts the values of the compaction constraints, the corresponding dimensions, positions, and shapes of the nest device change accordingly.

A hierarchy of an integrated circuit layout structure according to an exemplary embodiment of the invention has been shown and described. However, the invention is not limited to the specific embodiment shown in FIG. 2. For instance, there may be many more nest-level devices, each of which may have many more constituent leaf-level devices. On the other hand, these nest-level devices may be generated directly by user's scripts or by capturing an existing layout. Finally, the structure shown in FIG. 2 may have more constituent figure groups and devices than the number shown in FIG. 2.

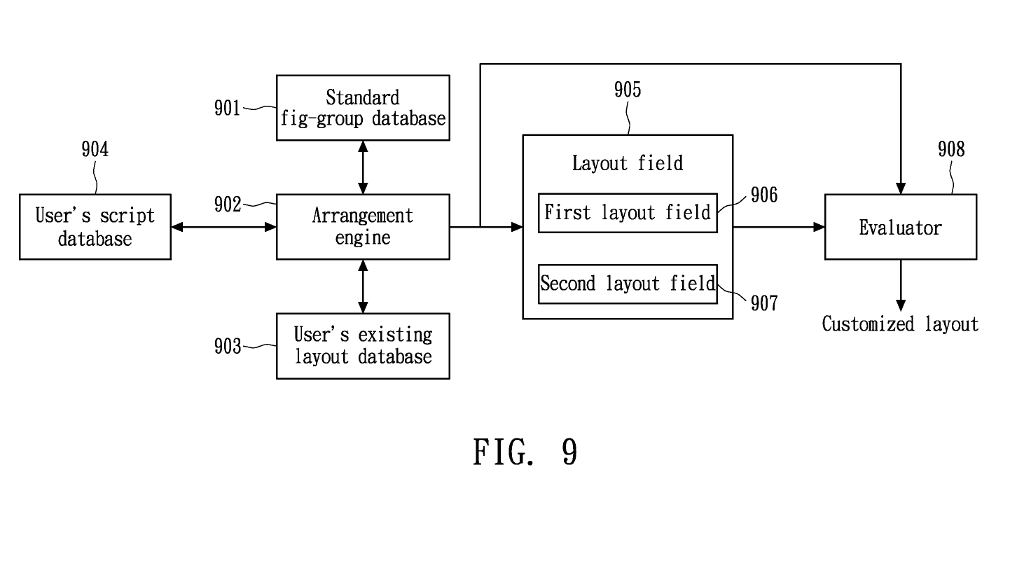

FIG. 9 shows a block diagram in accordance with one embodiment of the present invention. A basic figure group having at least one layer can be created in a layout field 905. Each layout field comprises a plurality of basic figure groups, leaf-level devices, or nest-level devices. For example, the first layout field 906 comprises a nest-level device and the second layout field 907 comprises a leaf-level device. The corresponding design parameters for the nest-level device in the first layout field 906 and the leaf-level device in the second layout field 907 are stored in a storage medium. These design parameters comprise a set of design rules and a set of design constraints that are specified by the user. In addition, the nest-level device in the first layout field 906 or the leaf-level device in the second layout field 907 can be utilized to create a complex device in the layout field 905. As mentioned above, figure groups, leaf-level devices, nest-level devices, or higher-level devices in these layout fields can be created by utilizing a plurality of built-in figure groups in the standard figure group database 901 through the arrangement engine 902.

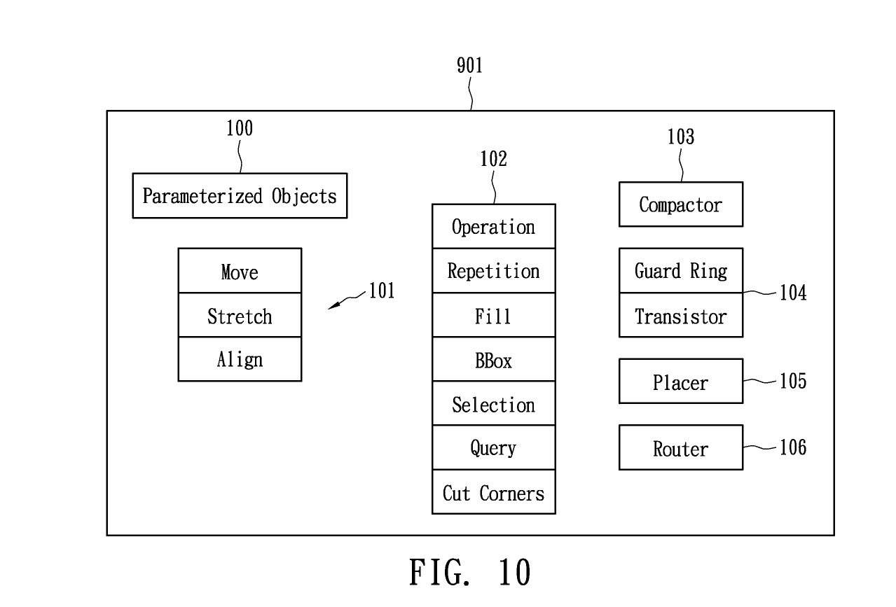

In FIG. 10, an exemplary stand figure group database 901 comprises parameterized objects 100, editors 101 including move, stretch and align, derived objects 102 including operation, repetition (absolute/relative), fill, bounding box, selection, query and cut corners, a compactor 103 which executes rule constraints, devices 104 including guard-ring and transistor, a placer 105 and a router 106. In addition, these figure groups and devices can also be created with the user's existing layout database 903 or user's script database 904. Finally, according to the compaction constraints specified by the user, a customized layout is constructed through the evaluator 908.

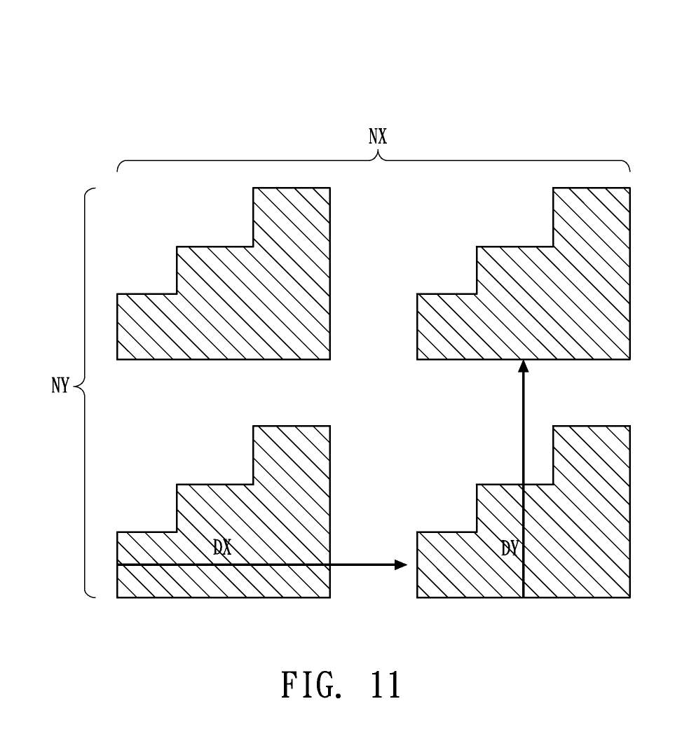

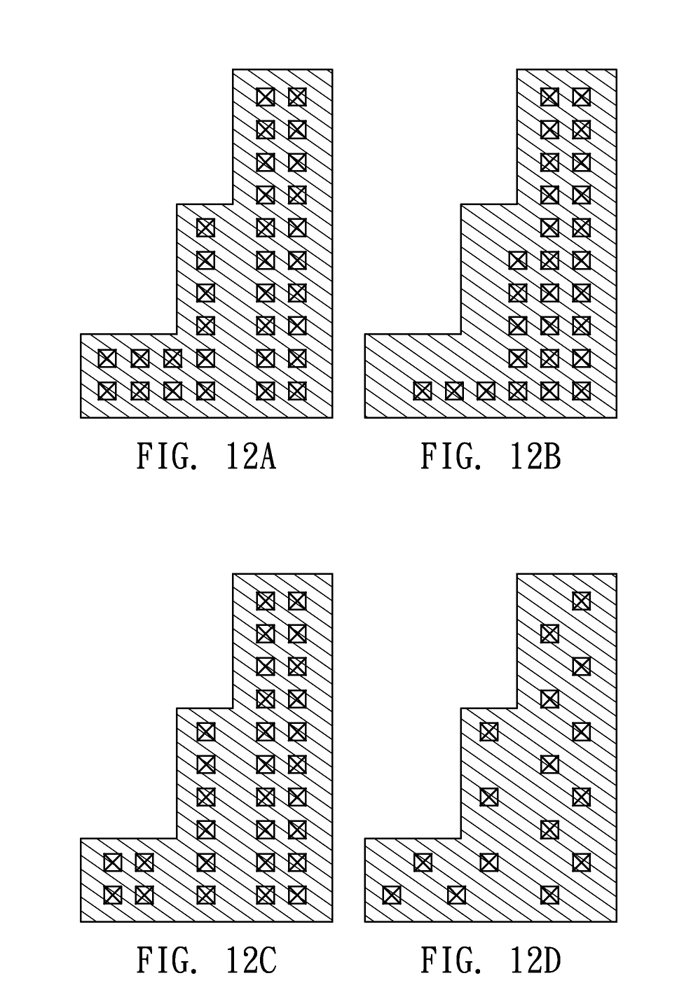

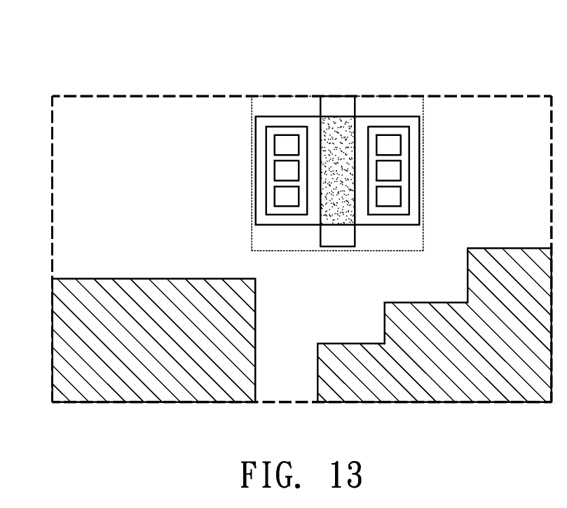

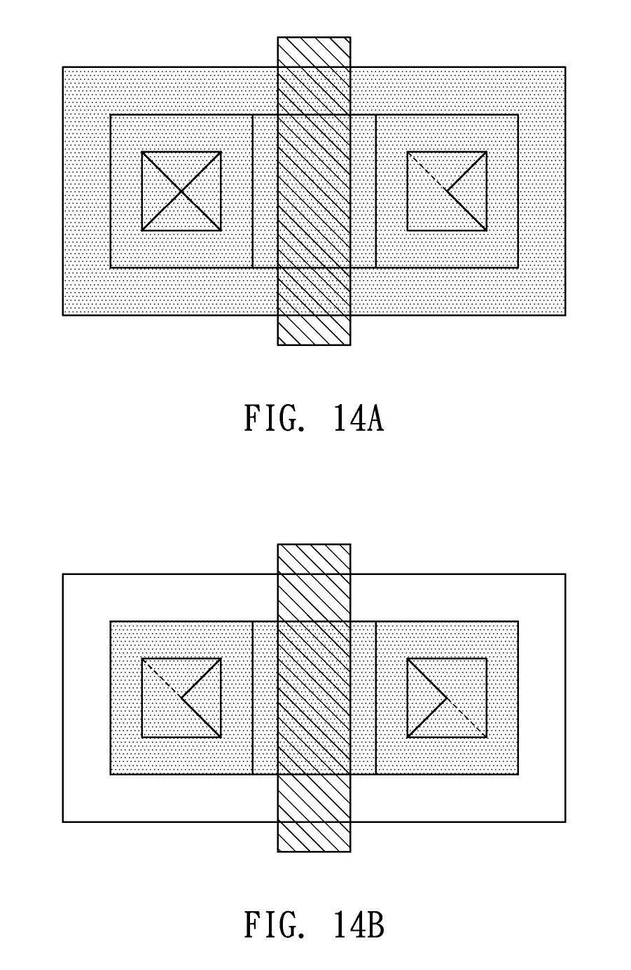

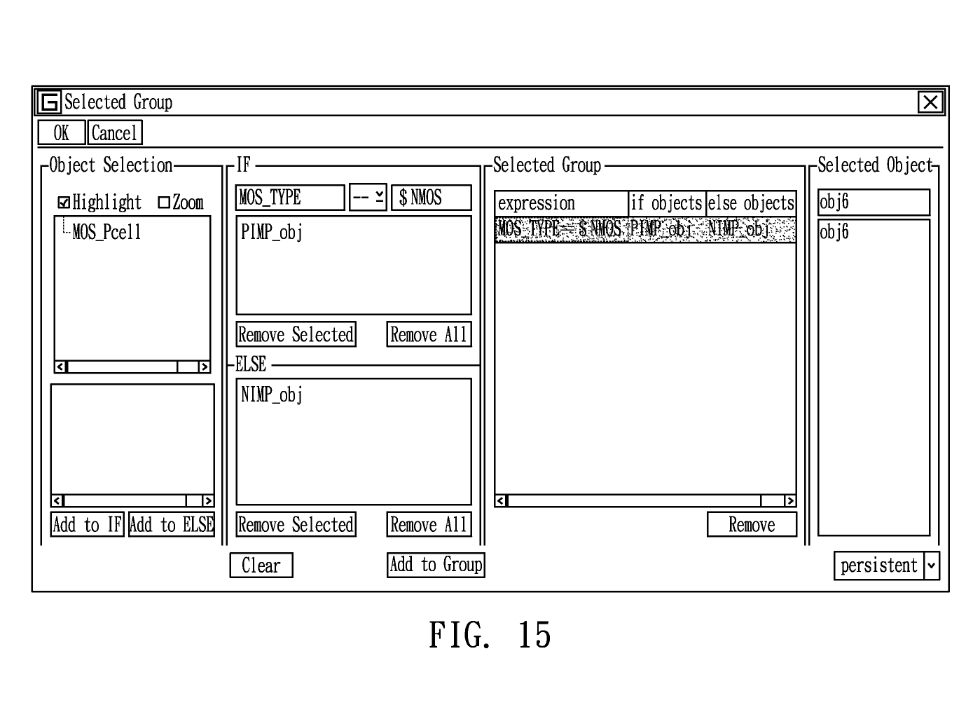

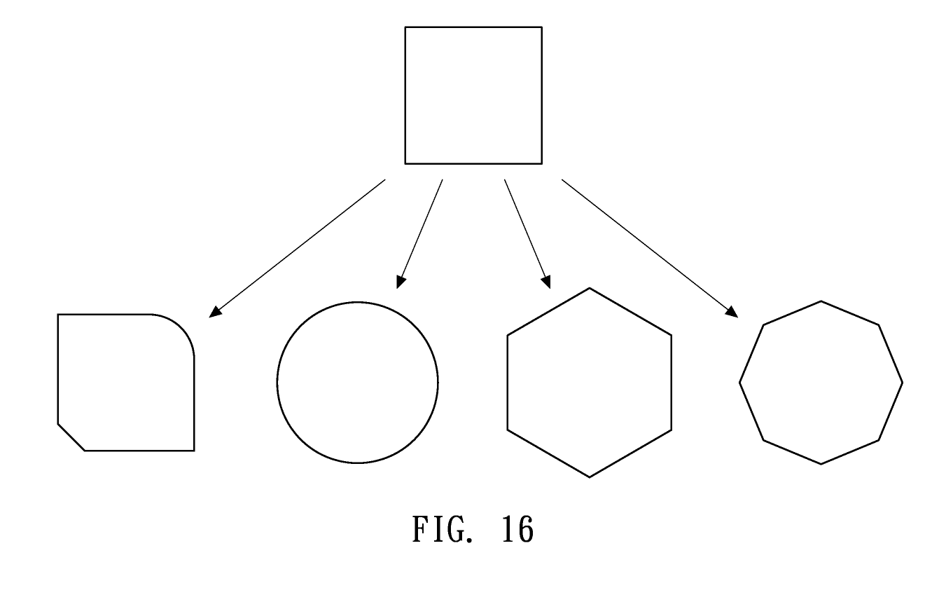

FIG. 11 shows an exemplary plot of a repetition of derived objects 102, wherein the NX/NY and the DX/DY are quantity parameter and distance parameter respectively. FIG. 12 shows an exemplary plot of a fill of derived objects 102, wherein the FIG. 12A shows an exemplary plot of a “Maximum” fill, FIG. 12B shows an exemplary plot of a “BigBase” fill, FIG. 12C shows an exemplary plot of a “Simple” fill and FIG. 12D shows an exemplary plot of a “Diagonal” fill. FIG. 13 shows an exemplary plot of the bounding box of the derived objects 102. FIG. 14 shows an exemplary plot of the selection of the derived objects 102. FIG. 14A shows an exemplary plot of the selection of an N-type implant doped area. FIG. 14B shows an exemplary plot of the selection of a P-type implant doped area. FIG. 15 shows an exemplary graphical user interface of the query of the derived objects 102. By utilizing the cut corners of the derived objects 102, processed shapes (as shown in FIG. 16) such as a circle, a hexagon or an octagon are obtained from a square.

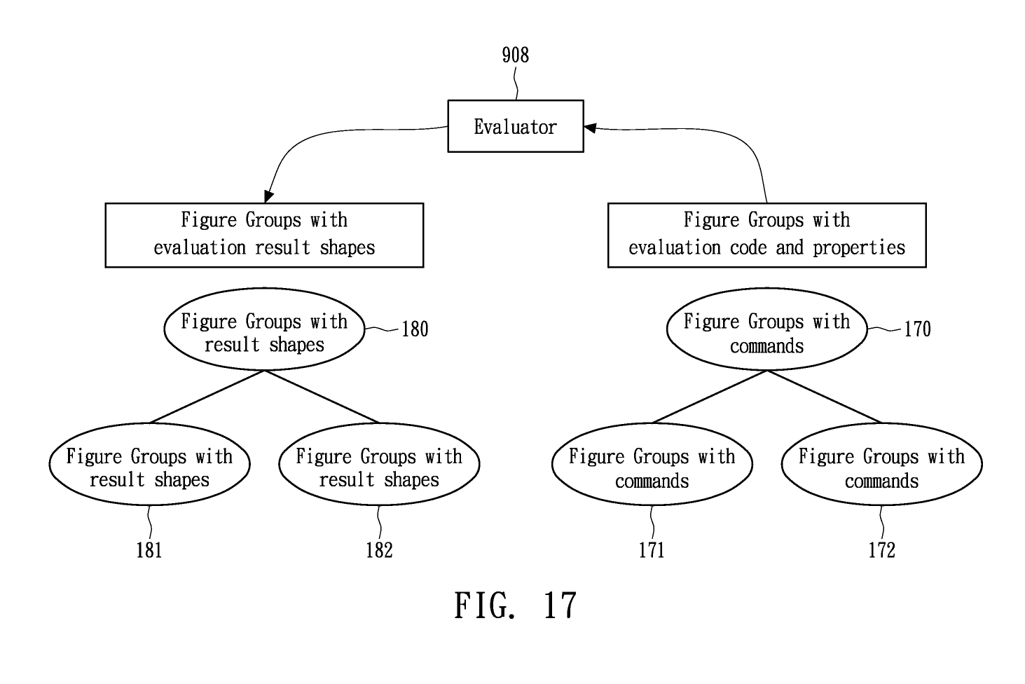

FIG. 17 shows a flow chart in accordance with one embodiment of the present invention. In FIG. 17, figure groups 170, 171, and 172 can be seen as the contents for above-mentioned layout fields 905-907, respectively. These figure groups may contain basic figure groups, leaf-level devices, nest-level devices or higher-level devices. The figure groups 170 and 180 can be regarded as higher-level figure groups defined by relating two lower-level figure groups, respectively. For figure groups 170-172, each figure group is defined by commands. These commands can be described by user scripts in code such as C language, C++, Tool Command Language (TCL), Python or Perl. With these commands, several parameterized figure groups can be generated simultaneously to form figure groups. The algorithms of the present invention can be implemented by a computer, processor or a controller. The user can design a layout from simple to complex with lower-level figure groups such as groups 171 and 172 forming the higher-level figure group 170. Moreover, the figure groups 170-172 are growth figure groups. That is, the user can add more commands for the higher-level figure group 170 or the lower-level figure groups 171, 172 to satisfy the design requirement. These groups can be persistent or temporary in the storage medium of the system. Once the user sets related compaction constraints for figure groups, the evaluator 908 will generate figure groups with the resulting shapes.

With layout tools currently available on the market, the coverage of the layout method provided is limited, and few specific layout patterns are supported. The present invention provides more options for users to flexibly create a customized figure group design. With the figure group concept of creating a figure group from user's scripts, greater efficiency and convenience is provided to the user to construct a higher-level and complex device.

The above-described embodiments of the present invention are intended to be illustrative only. Numerous alternative embodiments may be devised by persons skilled in the art without departing from the scope of the following claims.

What is claimed is:

1. A method for constructing a customized layout figure group, comprising the steps of:
arranging a customized layout figure group that is not present in a standard figure group database by reorganizing built-in figure groups in the standard figure group database, capturing a user's existing layout, executing codes of a user's scripts or the combination thereof;
setting compaction constraints for the customized layout figure group; and
generating the customized layout figure group in accordance with the compaction constraints;
wherein the customized layout figure group functions as supplement of the standard figure group database.

2. The method of claim 1, wherein the built-in figure groups comprise parameterized objects and layout groups.

3. The method of claim 2, wherein the parameterized objects comprise a rectangle, a polygon, a path, a path segment, a text, a polygon text, a scalar instance, an array instance, a path segment, an ellipse, and a donut.

4. The method of claim 2, wherein the layout groups comprise an editor, derived objects, a placer, a router, a compactor, devices and user program groups.

5. The method of claim 1, wherein the customized layout figure group has a set of design parameters affecting attributes of the customized figure group.

6. The method of claim 5, wherein the set of design parameters comprises design rules and modifiable design constraints.

7. The method of claim 1, wherein the user's scripts are written in C language, C++, Tool Command Language (TCL), Python, Perl or the combination thereof.

8. The method of claim 1, wherein the compaction constraints comprise design constraints, design rules and user-defined constraints.

9. A system for constructing a layout figure group, comprising:
a standard figure group database comprising a plurality of built-in figure groups;
an arrangement engine configured to reorganize built-in figure groups designated by a user; and
an evaluator connected to the arrangement engine for generating a customized layout figure group that is not present in the standard figure group database in accordance with compaction constraints requested by the user;
wherein the customized layout figure group functions as supplement of the standard figure group database.

10. The method of claim 9, wherein the plural built-in figure groups comprise parameterized objects and layout groups.

11. The method of claim 10, wherein the parameterized objects comprise a rectangle, a polygon, a path, a path segment, a text, a polygon text, a scalar instance, an array instance, a path segment, an ellipse, and a donut.

12. The method of claim 10, wherein the layout groups comprise an editor, derived objects, a placer, a router, a compactor, devices and user program groups.

13. The system of claim 9, further comprising a user's existing layout database, wherein the arrangement engine selectively reorganizes a user's existing layout stored in the user's existing layout database.

14. The system of claim 9, further comprising a user's script database, wherein the arrangement engine selectively captures a user's scripts stored in the user's script database.

15. The system of claim 13, further comprising a layout field configured to display the user's existing layout or the built-in figure groups.

16. The system of claim 9, wherein the customized layout figure group has a set of design parameters affecting attributes of the figure group.

17. The system of claim 16, wherein the set of design parameters comprises design rules and modifiable design constraints.

18. The system of claim 14, wherein the user's scripts are written in C language, C++, Tool Command Language (TCL), Python, Perl or the combination thereof.

19. The system of claim 9, wherein the compaction constraints comprise design constraints, design rules and user-defined constraints.

20. A system for constructing a layout figure group, comprising:
a standard figure group database comprising a plurality of built-in figure groups;
means for reorganizing built-in figure groups designated by a user;
means for reorganizing a user's existing layout; and
means for generating a customized layout figure group that is not present in the standard figure group database in accordance with compaction constraints requested by the user;
wherein the customized layout figure group functions as supplement of the standard figure group database.

21. The system of claim 20, further comprising means for capturing a user's scripts.
